(19) United States
(12) Patent Application Publication
(10) Pub. No.: US 2020/0272082 A1
(43) Pub. Date: Aug. 27, 2020

(54) IMAGE FORMING APPARATUS

(71) Applicant: KONICA MINOLTA, INC., Tokyo (JP)

(72) Inventor: Masahiro MATSUO, Tokyo (JP)

(21) Appl. No.: 16/799,974

(22) Filed: Feb. 25, 2020

(30) Foreign Application Priority Data
Feb. 27, 2019 (JP) 2019-034232

(51) Int. Cl. G03G 15/00

(52) U.S. Cl. CPC G03G 15/50; G03G 15/652

(57) ABSTRACT

There is provided an image forming apparatus that is capable of forming an image on a continuous paper, and the image forming apparatus includes: an image former including an image carrier on which a toner image is formed as being driven; and a hardware processor that controls conveyance of the continuous paper and driving of the image carrier, wherein the hardware processor starts the conveyance of the continuous paper while stopping the drive of the image carrier.

### CROSS REFERENCE TO RELATED APPLICATIONS

The present invention claims priority under 35 U.S.C. § 119 to Japanese Patent Application No. 2019-034232, filed on Feb. 27, 2019, is incorporated herein by reference in its entirety.

### BACKGROUND

### Technological Field

The present disclosure relates to an image forming apparatus.

### Description of the Related art

In recent years, an image forming system for forming an image on continuous paper such as roll paper or continuous form paper with perforations (continuous paper) has been developed. The image forming system includes a paper feeding device, an image forming apparatus, a winding device, and the like. In such an image forming system, the continuous paper may be shaken in the width direction. Since such shaking is a sine wave damped oscillation, it is converged and stabilized when the continuous paper is conveyed by a certain amount. In view of the above, there has been proposed a technique for starting image formation when the change in the position in the width direction is stabilized in accordance with the position in the width direction of the continuous paper (see, for example, JP 2016-126116 A).

However, in the related art as described in JP 2016-126116 A, an image carrier is kept driven while the continuous paper is being conveyed even when an image is not being written on the image carrier. Therefore, a gap is generated between a printing distance that is a distance at which writing is performed on the image carrier and a lubricant consumption distance that is a distance at which the image carrier is operated. Since a drum unit including the image carrier is replaced when either the printing distance or the lubricant consumption distance reaches the end of its life, the replacement frequency increases, resulting in high cost.

### SUMMARY

This disclosure is made in view of such a situation, and can reduce the exchange frequency of the drum unit.

To achieve the abovementioned object, according to an aspect of the present invention, there is provided an image forming apparatus that is capable of forming an image on a continuous paper, and the image forming apparatus reflecting one aspect of the present invention comprises: an image former including an image carrier on which a toner image is formed as being driven; and a hardware processor that controls conveyance of the continuous paper and driving of the image carrier, wherein the hardware processor starts the conveyance of the continuous paper while stopping the drive of the image carrier.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating an example of an overall configuration of an image forming apparatus according to an embodiment of the present disclosure;

FIG. 2 is a diagram schematically illustrating a part of the configuration of the image forming apparatus according to an embodiment of the present disclosure;

FIG. 3 is a flowchart illustrating a control example according to an embodiment of the present disclosure;

FIG. 4 is a flowchart illustrating a normal mode process according to an embodiment of the present disclosure;

FIG. 5 is a flowchart illustrating a life extension mode process according to an embodiment of the present disclosure;

FIG. 6A and FIG. 6B are timing charts of an image forming operation of the image forming apparatus according to an embodiment of the present disclosure; and

FIG. 7A and FIG. 7B are other timing charts of the image forming operation of the image forming apparatus according to an embodiment of the present disclosure.

### DETAILED DESCRIPTION OF EMBODIMENTS

Hereinafter, one or more embodiments of the present invention will be described with reference to the drawings. However, the scope of the invention is not limited to the disclosed embodiments.

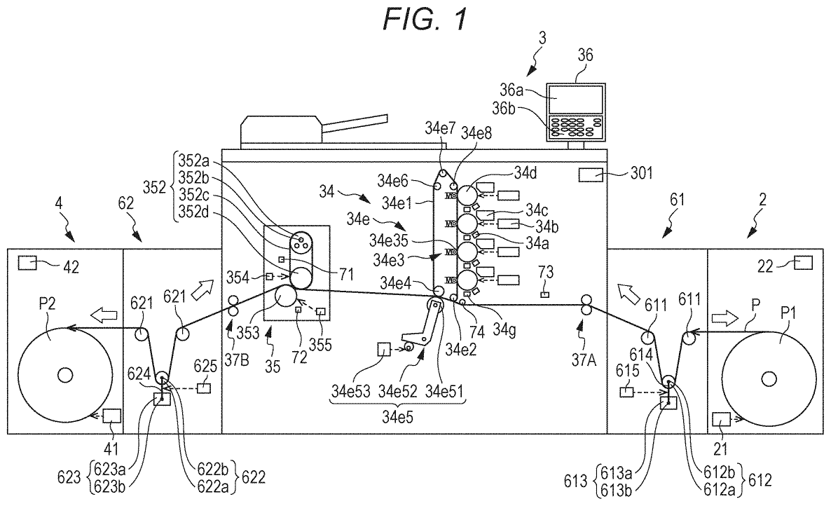

FIG. 1 is a diagram illustrating an overall configuration example of an image forming apparatus 3 according to an embodiment of the present disclosure. In the image forming apparatus 3, an image former 34, a fixing unit 35, and a controller 301 are included, a paper feeding device 2 and a tension applying mechanism 61 are provided in a preceding stage side, and a tension applying mechanism 62 and a winding device 4 are provided in a later stage side. The paper feeding device 2 is loaded with a roll of continuous paper P1. The winding device 4 stores a roll of continuous paper P2. Note that the rolls of continuous paper P1 and P2 are referred to as continuous paper P when described as a generic term. Further, the image forming apparatus 3 may have a configuration including at least one of the paper feeding device 2, the winding device 4, the tension applying mechanism 61, and the tension applying mechanism 62. The paper feeding device 2 includes a paper feeding drive unit 21 and a paper feeding control unit 22. The paper feeding drive unit 21 is composed of, for example, a servo motor, and controls a rotation speed of the continuous paper P1 by being driven based on a control command from the paper feeding control unit 22. The tension applying mechanism 61 is provided in a later stage side of the roll-shaped continuous paper P1, and applies tension to the continuous paper P1. The paper feeding device 2 feeds the continuous paper P1 to the image forming apparatus 3 via the tension applying mechanism 61 so that the tension-applied continuous paper P1 is fed to the image forming apparatus 3.

The tension applying mechanism 61 includes two driven rollers 611, a dancer roller 612, a weight 613, a support member 614, and an air damper 615. The dancer roller 612 includes a roller body 612a and a roller support shaft 612b, and the roller body 612a can move up and down together with the roller support shaft 612b. The weight 613 includes a weight body 613a and a weight support shaft 613b. The tension is determined according to the weight of the weight 613. A load by the weight 613 is applied to the dancer roller 612 via the support member 614 that connects the roller support shaft 612b and the weight support shaft 613b. The support member 614 is held by the air damper 615. When the pressure of the air damper 615 is reduced, a holding force of the weight 613 by the support member 614 is reduced and the load of the weight 613 applied to the dancer roller 612 is increased, so that the tension applied to the continuous paper P increases.

The tension applying mechanism 62 includes two driven rollers 621, a dancer roller 622, a weight 623, a support member 624, and an air damper 625. The dancer roller 622 includes a roller body 622a and a roller support shaft 622b, and the roller body 622a can move up and down together with the roller support shaft 622b. The weight 623 includes a weight body 623a and a weight support shaft 623b. The tension is determined according to the weight of the weight 623. A load by the weight 623 is applied to the dancer roller 622 via the support member 624 that connects the roller support shaft 622b and the weight support shaft 623b. The support member 624 is held by the air damper 625. When the pressure of the air damper 625 is reduced, the holding force of the weight 623 by the support member 624 is reduced, and the load of the weight 623 applied to the dancer roller 622 is increased, so that the tension applied to the continuous paper P increases.

In other words, the continuous paper P is supported by the dancer roller 612 and the two driven rollers 611, so that the dancer roller 612 is supported with the two driven rollers 611 so as to be rotated in the rotational direction and movable up and down while the range of movement in the vertical direction is restricted. In a similar manner, the continuous paper P is supported by the dancer roller 622 and the two driven rollers 621, so that the dancer roller 622 is supported with the two driven rollers 621 so as to be rotated in the rotational direction and movable up and down while the range of movement in the vertical direction is restricted. Therefore, the rotation speeds of the servo motors of the paper feeding drive unit 21 and a later described winding drive unit 41 are controlled so that the positions of the dancer rollers 612 and 622 are kept at predetermined positions. In other words, the positions of the dancer rollers 612 and 622 depend on the input/output speed difference between the paper feeding drive unit 21 and the winding drive unit 41. Note that, in a case where power is not supplied to the paper feeding device 2 and the winding device 4, that is, a case where the power is cut off, since the paper feeding drive unit 21 and the winding drive unit 41 are not energized, the dancer rollers 612 and 622 falls with the load applied by the weights 613 and 623 and their own weight to the lower limit of the movement range. As a result, no tension is applied to the continuous paper P.

In the winding device 4, the continuous paper P on which an image is formed by the image forming apparatus 3 is wound and stored as the roll-shaped continuous paper P2. The winding device 4 includes the winding drive unit 41 and a winding control unit 42. The winding drive unit 41 is constituted by, for example, a servo motor, and controls the rotation speed of the continuous paper P2 by being driven based on the control command of the winding control unit 42. The tension applying mechanism 62 is provided on the preceding stage side of the roll-shaped continuous paper P2, and applies tension to the continuous paper P. The winding device 4 stores the continuous paper P output from the image forming apparatus 3 as the continuous paper P2 to which tension is applied, by winding as a roll-shaped continuous paper P2 via the tension applying mechanism 62. Here, in the image forming apparatus 3, the continuous paper P is transported by an upstream conveyance roller pair 37A and a downstream conveyance roller pair 37B, passes through the image former 34, and the fixing unit 35, and is discharged. Note that an end detector 73 is provided in a conveyance path between the upstream conveyance roller pair 37A and a transfer unit 34e. The end detector 73 is constituted by, for example, a reflective photoelectric sensor, and detects an edge of the continuous paper P in the main scanning direction. With this configuration, the end detector 73 can detect the position of the edge of the continuous paper P in the main scanning direction. Therefore, deviation of the continuous paper P is detected according to a displacement of the edge in the main scanning direction of the continuous paper P detected at regular intervals by the end detector 73.

The image forming apparatus 3 includes a setting unit 36 at the top portion. The setting unit 36 includes a display unit 36a and an operation unit 36b, receives user operation via the operation unit 36b, and displays information on the display unit 36a. The image forming apparatus 3 includes, on the top portion, an automatic document feeder and a document image scanning device that automatically read a document. The document image scanning device can read an image through a platen glass. The document image scanning device reads an image of a document, for example, and the image is used to form an image by the image former 34. The image former 34 includes image carriers 34d respectively prepared for each color such as cyan, magenta, yellow, black, and the like, and a charging device 34a, an exposure device 34b, and a developing device 34c are provided in the vicinity of each image carrier 34d. Note that the image carrier 34d is composed of, for example, a drum-shaped photoconductor.

A surface of the image carrier 34d charged by the charging device 34a is exposed to an image by the exposure device 34b based on the original image data of the print job, and an electrostatic latent image is formed. In the image carrier 34d, the electrostatic latent image is developed by the developing device 34c to form a toner image. The transfer unit 34e includes an intermediate transfer belt 34e1, a pressing unit 34e5, and the like. The transfer unit 34e transfers the toner image transferred to the intermediate transfer belt 34e1 onto the continuous paper P via a transfer nip (secondary transfer nip) formed by a pressing unit 34e5 that can be pressed to the intermediate transfer belt 34e1. The fixing unit 35 performs a fixing process on the continuous paper P to which the toner image has transferred. Note that, although the details will be described later, the pressing unit 34e5 includes a secondary transfer roller 34e51, a secondary transfer adjustment unit 34e52, and a secondary transfer driving unit 34e53, and the secondary transfer adjustment unit 34e52 adjusts the position of the secondary transfer roller 34e51 according to a driving force of the secondary transfer driving unit 34e53.

The transfer unit 34e includes a belt cleaning device, which is not illustrated. The belt cleaning device includes a belt cleaning blade and the like, and is in slidingly contact with the surface of the intermediate transfer belt 34e1. The belt cleaning device removes transfer residual toner remaining on the surface of the intermediate transfer belt 34e1 after the secondary transfer.

The intermediate transfer belt 34e1 is formed of an endless belt. The intermediate transfer belt 34e1 includes a driving roller 34e2, a primary transfer pressure adjusting unit 34e3 including a primary transfer roller 34e35, an opposing roller 34e4, a driven roller 34e6, a steering roller 34e7, and a driven roller 34e8 on the inner peripheral side. Therefore, the intermediate transfer belt 34e1 is stretched in a loop shape by the driving roller 34e2, the primary transfer pressure adjusting unit 34e3, the opposing roller 34e4, the driven roller 34e6, the steering roller 34e7, and the driven roller 34e8. The driving roller 34e2 is disposed on the downstream side in the belt traveling direction from the primary transfer pressure adjusting unit 34e3 for the K component. As the driving roller 34e2 rotates, the intermediate transfer belt 34e1 travels at a constant speed in the clockwise direction. The opposing roller 34e4 is disposed on the downstream side of the driving roller 34e2, and faces the secondary transfer roller 34e51. The driven roller 34e6 is disposed above (downstream side) the opposing roller 34e4. The steering roller 34e7 is on the downstream side of the driven roller 34e6 and on the upstream side of the primary transfer pressure adjusting unit 34e3 for the Y component, which is located at the most upstream in the rotation direction of the intermediate transfer belt 34e1 in the plurality of primary transfer pressure adjusting units 34e3. The driven roller 34e8 is provided between the Y component primary transfer pressure adjusting unit 34e3 and the steering roller 34e7. In addition, between the Y component primary transfer pressure adjusting unit 34e3 and the K component primary transfer pressure adjusting unit 34e3, the primary transfer pressure adjusting units 34e3 for the M component and C component are arranged in order from the Y component side.

Each of the plurality of primary transfer pressure adjustment units 34e3 is provided on the inner peripheral surface side of the intermediate transfer belt 34e1, and is disposed at a position facing each of the plurality of image carriers 34d. In other words, each of the primary transfer rollers 34e35 included in the plurality of primary transfer pressure adjusting units 34e3 is pressed against each of the plurality of image carriers 34d via the intermediate transfer belt 34e1. With such an arrangement, a primary transfer nip is formed between each of the plurality of image carriers 34d and each of the plurality of primary transfer rollers 34e35. In the primary transfer nip, a toner image is transferred from each of the plurality of image carriers 34d to the intermediate transfer belt 34e1.

The secondary transfer roller 34e51 is provided on the outer peripheral surface side of the intermediate transfer belt 34e1. The secondary transfer roller 34e51 is called a backup roller, and is brought into pressure contact with the intermediate transfer belt 34e1 and a secondary transfer nip is formed. In the secondary transfer nip, the toner image is transferred from the intermediate transfer belt 34e1 to the continuous paper P. When the intermediate transfer belt 34e1 passes through the primary transfer nip, the toner images on the plurality of image carriers 34d are primarily transferred onto the intermediate transfer belt 34e1 in sequence. Specifically, when a primary transfer bias is applied to the primary transfer roller 34e35, a charge having a polarity opposite to that of the toner included in the toner image is generated on the back surface side of the intermediate transfer belt 34e1 where the intermediate transfer belt 34e1 contacts with the primary transfer roller 34e35, and the toner image is electrostatically transferred to the intermediate transfer belt 34e1.

When the toner image is electrostatically transferred to the intermediate transfer belt 34e1 and the continuous paper P passes through the secondary transfer nip, the toner image on the intermediate transfer belt 34e1 is secondarily transferred to the continuous paper P. Specifically, when a secondary transfer bias is applied to the secondary transfer roller 34e51, a charge having a polarity opposite to that of the toner is applied to the side of the back surface of the continuous paper P where the continuous paper P contacts with the secondary transfer roller 34e51, and the toner image is electrostatically transferred onto the continuous paper P. The continuous paper P to which the toner image has been transferred is conveyed toward the fixing unit 35.

The secondary transfer adjustment unit 34e52 is formed of an L-shaped member, and includes a long piece, a short piece, and a cam. The long piece has a distal end portion rotatably supporting the secondary transfer roller 34e51, and a proximal end portion constitutes a bent portion. The bent portion is supported by a support pin so as to be swingable, and engages the short piece. Therefore, according to the driving force of the secondary transfer driving unit 34e53, when the cam pushes the short piece with the transfer pressing force, the long piece rotates about the support pin, and the secondary transfer roller 34e51 pushes the intermediate transfer belt 34e1 upward so that the secondary transfer nip is formed. Since a pre-transfer conveyance roller 74 is provided at a position before transfer in the secondary transfer nip, tension is applied to the continuous paper P by the pre-transfer conveyance roller 74. This tension is applied to the continuous paper P in order to suppress the meandering amount of the continuous paper P. Further, the transfer pressing force is to press the secondary transfer roller 34e51 against the intermediate transfer belt 34e1 to form a secondary transfer nip.

Note that, in the transfer unit 34e, instead of the secondary transfer roller 34e51, a configuration in which an unillustrated secondary transfer belt is stretched in a loop on an unillustrated plurality of support rollers including the secondary transfer roller 34e51, so-called a belt-type secondary transfer unit may be employed.

The fixing unit 35 includes a first rotating member 352 and a second rotating member 353. The first rotating member 352 includes a heating roller 352a, a heating source 352b, a fixing belt 352c, and an upper pressure roller 352d. The heating source 352b is provided inside the heating roller 352a to be capable of raising the temperature, and heats the heating roller 352a. The upper pressure roller 352d is provided below the heating roller 352a. The fixing belt 352c has an endless shape and is wound around the heating roller 352a and the upper pressure roller 352d. When the second rotating member 353 functioning as a lower pressure roller is pressed against the upper pressure roller 352d, a fixing nip is formed via the fixing belt 352c. Note that, in a case where the second rotating member 353 is separated from the upper pressure roller 352d, which is the first rotating member 352, the fixing nip is released. Even in a case where the fixing nip is released, when the tension is applied to the continuous paper P, the continuous paper P is made wound around the second rotating member 353.

The first rotating member 352 is driven by an upper drive unit 354. The upper drive unit 354 is controlled by the controller 301 to cause the first rotating member 352 to travel at a constant speed. For example, by driving the upper pressure roller 352d, the fixing belt 352c travels at a constant speed, and the heat supplied from the heating roller 352a via the fixing belt 352c is transferred to the fixing nip formed on the upper pressure roller 352d. Therefore, the temperature of the fixing belt 352c can be regarded as the temperature of the first rotating member 352. The second rotating member 353 is driven by a lower drive unit 355. The lower drive unit 355 is controlled by the controller 301 to separate the second rotating member 353 from the first rotating member 352 or press the second rotating member 353 against the first rotating member 352. In other words, the positional relationship between the upper pressure roller 352d and the second rotating member 353 functioning as the lower pressure roller is either one of the separated state and the pressure contact state.

An upper temperature detector 71 is provided at a position facing the fixing belt 352c. The upper temperature detector 71 detects the temperature of the fixing belt 352c. A lower temperature detector 72 may be provided in the vicinity of the second rotating member 353. The lower temperature detector 72 detects the temperature around the second rotating member 353. The second rotating member 353 receives heat from the first rotating member 352 via the fixing nip, but the same material as the heating source 352b may be provided inside the second rotating member 353.

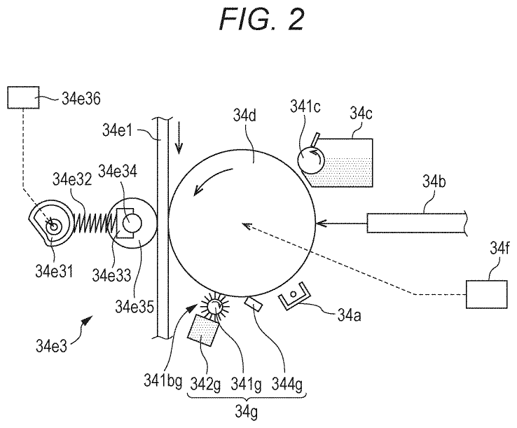

In other words, the image former 34 can form an image on the continuous paper P by an electrophotographic method. A drum cleaning device 34g is provided in the vicinity the image carrier 34d. The drum cleaning device 34g removes residual toner remaining in the transfer unit 34e. Details of the drum cleaning device 34g will be described later with reference to FIG. 2. The controller 301 includes a CPU, a ROM, a RAM, an I/O interface, and the like (not shown), and is used as a computer that controls the image forming apparatus 3. The CPU reads out a program from the ROM according to the processing contents, expands the program in the RAM, and controls the operation of the image forming apparatus 3 in cooperation with the expanded program. The program is for realizing various control functions. The controller 301 is also used as a processor mainly composed of a CPU.

Next, the image forming operation will be specifically described with reference to FIG. 2. FIG. 2 is a diagram schematically illustrating a part of the configuration of the image forming apparatus 3 according to the embodiment of the present disclosure. The image carrier 34d is made of an organic photoreceptor in which a photosensitive layer made of a resin containing an organic photoconductor is formed on an outer peripheral surface of, for example, a drum-shaped metal substrate. As resins composing the photosensitive layer, there may be polycarbonate resins, silicone resins, polystyrene resins, acrylic resins, methacrylic resins, epoxy resins, polyurethane resins, vinyl chloride resins, melamine resins, and the like. The image carrier 34d is rotationally driven by an image carrier drive motor 34f. The developing device 34c includes a developing sleeve 341c disposed so as to face the image carrier 34d with a developing area interposed therebetween. The developing sleeve 341c is applied with, for example, a DC developing bias having the same polarity as the charging polarity of the charging device 34a or a developing bias in which a DC voltage having the same polarity as the charging polarity of the charging device 34a is superimposed on the AC voltage. With this configuration, reversal development is performed to attach toner to the electrostatic latent image formed by the exposure device 34b.

The toner image formed on the image carrier 34d by the developing device 34c is formed with the intermediate transfer belt 34e1, and is carried to the primary transfer pressure adjusting unit 34e3. The primary transfer pressure adjusting unit 34e3 includes a primary transfer pressure adjusting cam 34e31, a biasing member 34e32, a gripping part 34e33, a shaft part 34e34, and a primary transfer driving unit 34e36 in addition to the primary transfer roller 34e35 described above. The primary transfer pressure adjusting cam 34e31 is configured by using an eccentric cam in which the distance (diameter) between the rotation shaft and the outer peripheral surface continuously increases with the clockwise rotation (positive direction). The position (angle) of the primary transfer pressure adjusting cam 34e31 is changed according to the attitude (tilt angle) of the steering roller 34e7 under the control of the controller 301. Therefore, the pressing force of the primary transfer roller 34e35 is adjusted in the posture of the steering roller 34e7, and the primary transfer pressure is adjusted to be constant. Note that, the eccentric cam whose diameter increases in the clockwise direction (forward rotation) has been described as the primary transfer pressure adjusting cam 34e31; however, a cam having an opposite structure or other structure may be used.

For example, an elastic body such as a spring member is used as the biasing member 34e32, one end of which is in contact with the outer peripheral surface of the primary transfer pressure adjusting cam 34e31, and the other end is fixed to a part of the surface of the gripping part 34e33. The gripping part 34e33 grips the primary transfer roller 34e35 so as to be movable via the shaft part 34e34 of the primary transfer roller 34e35. When the primary transfer pressure adjusting cam 34e31 is rotated about the rotation shaft by the primary transfer driving unit 34e36, the distance (diameter) between the rotation center of the primary transfer pressure adjusting cam 34e31 and the outer peripheral surface in contact with the biasing member 34e32 changes. The stroke of the biasing member 34e32 changes due to the change in the diameter of the primary transfer pressure adjusting cam 34e31. The biasing member 34e32 moves the primary transfer roller 34e35 toward the image carrier 34d by pressing the primary transfer roller 34e35 in the horizontal direction by an elastic force corresponding to the stroke. Here, the primary transfer pressure adjusting unit 34e3 may be configured to change the inclination of the shaft part 34e34 of the primary transfer roller 34e35 with respect to the width direction of the intermediate transfer belt 34e1.

Next, the drum cleaning device 34g will be described. The drum cleaning device 34g includes a brush 341g, a solid lubricant 342g, and a cleaning blade 344g. The brush 341g has brush bristles 341bg made of, for example, polyester or nylon on the surface, and is arranged so as to contact both the solid lubricant 342g and the image carrier 34d. The brush 341g has a rotation shaft parallel to the rotation shaft of the image carrier 34d, and rotates at the contact point with the image carrier 34d in a direction in which the surface advances in the same direction as the advancing direction of the surface of the image carrier 34d. At this time, the brush 341g has functions for supplying lubricant particles scraped from the solid lubricant 342g to the image carrier 34d, spreading and applying the lubricant particles on the image carrier 34d by contact pressure, and removing toner which remains on the image carrier 34d. Note that, as a material for the solid lubricant 342g, a material that can be applied to the surface of the image carrier 34d and that can reduce surface energy to reduce the adhesion between the toner and the image carrier 34d is selected.

According to the above description, the image carrier 34d is rotated to start image formation. When the image carrier 34d is driven to rotate, the solid lubricant 342g is continuously supplied to the image carrier 34d. Therefore, even while the continuous paper P is being conveyed to converge the meandering of the continuous paper P, the solid lubricant 342g continues to be scraped off as the image carrier 34d is driven to rotate, so that it is concerned that the life of the lubricant consumption distance of the solid lubricant 342g, which is the distance that the image carrier 34d has operated may be reached earlier than the life of the printing distance written on the image carrier 34d. This causes a situation that a drum unit including the image carrier 34d and the drum cleaning device 34g is replaced.

Specifically, the drum unit is replaced when the life of either one of the printing distance and the lubricant consumption distance comes to an end. In the printing of the continuous paper P, when the continuous paper P is conveyed for a certain distance in order to prevent meandering of the continuous paper P before writing, the printing distance is not counted but the lubricant consumption distance is counted. Therefore, a gap is generated between the printing distance and the lubricant consumption distance. Therefore, when a small number of prints are repeated many times by the user, to adjust image quality, image position or the like, the gap between the printing distance and the lubricant consumption distance is further widened, even in a case where the printing distance life has not come to an end, the life of the lubricant consumption distance comes to an end first, and the drum unit is replaced.

Therefore, in order to reduce the gap between the printing distance and the lubricant consumption distance, the start of driving of the image carrier 34d is delayed when starting image formation. Specifically, the driving of the image carrier 34d is started after the continuous paper P is conveyed for a certain period of time or a certain distance at the printing speed. Further, as described above, since the end detector 73 can detect the deviation of the continuous paper P, after the conveyance of the continuous paper P is started at the printing speed, the driving of the image carrier 34d is started when the detection result of the end detector 73 of the deviation of the continuous paper P is equal to or lower than the threshold value.

Note that, it is assumed that the deviation of the continuous paper P does not fall equal to or lower than the threshold value even when the continuous paper P is continuously conveyed at the printing speed. In such an assumption, the standby time of the image carrier 34d is set to a certain period of time in advance, and when the continuous conveyance time after the start of the conveyance of the continuous paper P has reached the certain period of time, the convey of the continuous paper P may be started.

Further, in a case where image formation is started by the image carrier 34d, the primary transfer nip needs to be formed. The primary transfer nip is formed after the image carrier 34d is driven, thereby avoiding unnecessary sliding between the image carrier 34d and the intermediate transfer belt 34e1.

Further, an operation mode for delaying the drive of the image carrier 34d is a life extension mode; however, a normal mode, which is an operation mode that the driving of the image carrier 34d is started before the conveyance of the continuous paper P is started at the printing speed, is preferable in a case where the image quality needs to be adjusted before starting printing, the productivity needs to be improved, or an amount or waste continuous paper P needs to be reduced by reducing conveyance of the continuous paper P before image formation. Therefore, the controller 301 selects one of the life extension mode or the normal mode according to the switching of the operation mode.

Specifically, the operation mode can be manually switched by user setting. Further, in a case where the operation mode is automatically switched, the controller 301 determines whether the automatic switching condition is met. In a case where it is determined that the automatic switching condition is met, the normal mode is executed. For example, in a case where the controller 301 determines that the paper type is paper that is easy to meander and has weak stiffness, the normal mode is selected. In addition, the automatic switching condition is set, for example, whether the printing distance and the lubricant consumption distance are short or not. In a case where it is determined that the printing distance and the lubricant consumption distance are close to an end, the controller 301 selects the life extension mode in order to reduce the gap between the printing distance and the lubricant consumption distance even when waste of the continuous paper P increases. In other words, in the case where priority is given to reducing the reduction of the continuous paper P over the life of the image carrier 34d, the controller 301 starts driving the image carrier 34d before starting the conveyance of the continuous paper P at the printing speed.

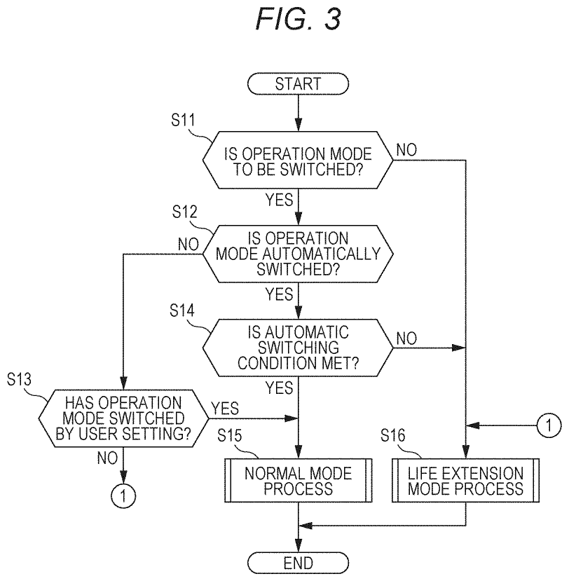

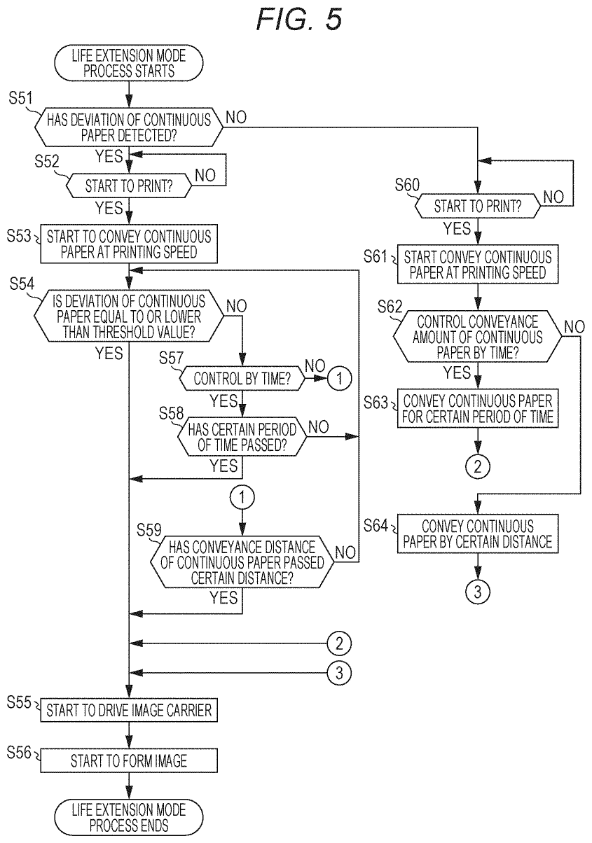

FIG. 3 is a flowchart illustrating a control example according to the embodiment of the present disclosure. In step S11, the controller 301 determines whether the operation mode is to be switched. When determining that the operation mode is to be switched (step S11; Y), the controller 301 proceeds to the process of step S12. When determining that the operation mode is not switched (step S11; N), the controller 301 proceeds to the process of step S16, executes the life extension mode process in step S16, and ends the process. Details of the life extension mode processing will be described later with reference to FIG. 5.

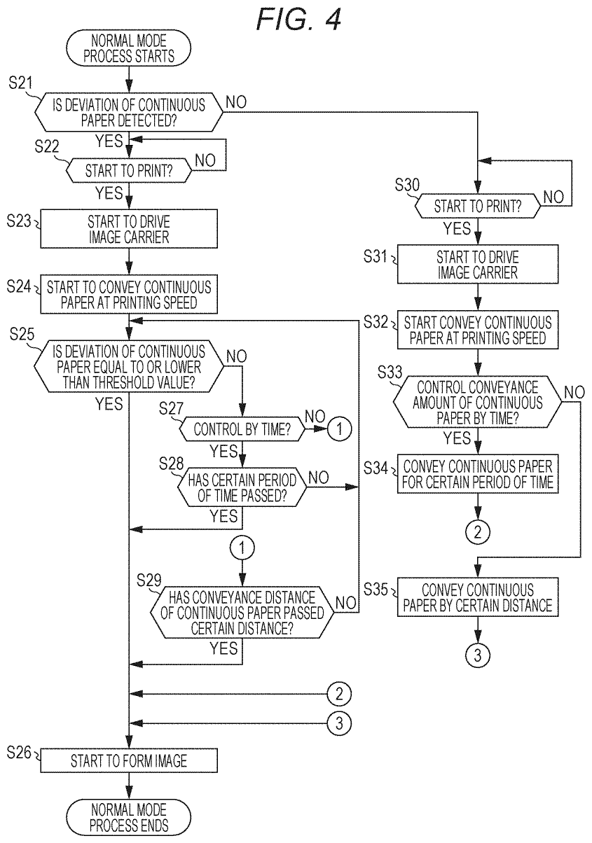

In step S12, the controller 301 determines whether or not the operation mode is in an automatic switching process. When determining that the operation mode is in the automatic switching process (step S12; Y), the controller 301 proceeds to the process of step S14. When determining that the operation mode is not in the automatic switching process (step S12; N), the controller 301 proceeds to the process of step S13. In step S13, the controller 301 determines whether or not the operation mode has been switched by the user setting. When the controller 301 determines that the operation mode has been switched by the user setting (step S13; Y), the controller 301 proceeds to the process of step S15, executes the normal mode process in step S15, and ends the process. Details of the normal mode processing will be described later with reference to FIG. 4. When determining that the operation mode has not been switched by the user setting (step S13; N), the controller 301 proceeds to step S16, executes a life extension mode process in step S16, and ends the process. In step S14, the controller 301 determines whether or not the automatic switching condition is met. When determining that the automatic switching condition is met (step S14; Y), the controller 301 proceeds to the process of step S15, executes the normal mode process in step S15, and ends the process. When determining that the automatic switching condition is not met (step S14; N), the controller 301 proceeds to the process of step S16, executes the life extension mode process in step S16, and ends the process.

FIG. 4 is a flowchart illustrating the normal mode processing according to an embodiment of the present disclosure. In step S21, the controller 301 determines whether or not a deviation of the continuous paper P is detected. When determining that the deviation of the continuous paper P is detected (step S21; Y), the controller 301 proceeds to the process of step S22. When determining that the deviation of the continuous paper P is not detected (step S21; N), the controller 301 proceeds to the process of step S30. In step S22, the controller 301 determines whether to start printing. When determining to start printing (step S22; Y), the controller 301 proceeds to the process of step S23. When determining that the printing is not started (step S22; N), the controller 301 continues the process of step S22.

In step S23, the controller 301 starts driving the image carrier 34d, and proceed to the process of step S24. In step S24, the controller 301 starts conveyance of the continuous paper P at the printing speed, and proceed to the process of step S25. In addition, when starting the conveyance of the continuous paper P at the printing speed, the controller 301 also controls an upstream conveyance roller pair 37A and a downstream conveyance roller pair 37B together.

In step S25, the controller 301 determines whether or not the deviation of the continuous paper P is equal to or lower than a threshold value. When determining that the deviation of the continuous paper P is equal to or lower than the threshold (step S25; Y), the controller 301 proceed to the process of step S26, starts the image formation in step S26, and ends the process. When determining that the deviation of the continuous paper P is not equal to or lower than the threshold (step S25; N), that is, when the controller 301 determines that the deviation of the continuous paper P exceeds the threshold (step S25; N), the controller 301 proceeds to the process of step S27. Note that, the threshold value is set to a value within a tolerance range in which the deviation of the continuous paper P is allowed. In addition, starting the image formation represents to start driving the image carrier 34d, form a primary transfer nip to enable the primary transfer, and then to start writing to the image carrier 34d by the exposure device 34b.

In step S27, the controller 301 determines whether to control by time. When determining to control by time (step S27; Y), the controller 301 proceeds to the process of step S28. When determining not to control by time (step S27; N), the controller 301 proceeds to the process of step S29. In step S28, the controller 301 determines whether or not a certain period of time has passed. When determining that the certain period of time has elapsed (step S28; Y), the controller 301 proceeds to the process of step S26. When determining that the predetermined time has not elapsed (step S28; N), the controller 301 returns to the process of step S25. In step S29, the controller 301 determines whether or not the conveyance distance of the continuous paper P has passed a certain distance. When determining that the conveyance distance of the continuous paper P has passed a certain distance (step S29; Y), the controller 301 proceeds to the process of step S26. When determining that the conveyance distance of the continuous paper P has not passed the predetermined distance (step S29; N), the controller 301 returns to the process of step S25.

In step S30, the controller 301 determines whether to start printing. When determining to start printing (step S30; Y), the controller 301 proceeds to the process of step S31. When determining not to start printing (step S30; N), the controller 301 continues the process of step S30. In step S31, the controller 301 starts driving the image carrier 34d, and proceeds to the process of step S32. In step S32, the controller 301 starts conveying the continuous paper P at the printing speed, and proceeds to the process of step S33. In step 33, the controller 301 determines whether to control the conveyance amount of the continuous paper P by time. When determining that the conveyance amount of the continuous paper P is controlled by time (step S33; Y), the controller 301 proceeds to the process of step S34 and, conveys the continuous paper P is conveyed for a certain period of time in step S34 and proceed to the process of step S26. When determining that the conveyance amount of the continuous paper P is not controlled by time (step S33; N), the controller 301 shifts to the processing of step S35, conveys the continuous paper P by a certain distance in step S35, and proceeds to the process of step S26.

FIG. 5 is a flowchart for describing a life extension mode process according to the embodiment of the present disclosure. Since the processing of steps S51 to S54 and steps S56 to S64 is the same as the processing of steps S21, S22, S24, S25, S26 to S30, and S32 to S35, explanation thereof will be omitted. The life extension mode process is different from a normal mode process in that a process for starting driving of the image carrier 34d in step S55 is executed as a pre-process of the process for starting image formation in step S56. In other words, the difference is that the normal mode process starts the driving of the image carrier 34d in the pre-process for starting the conveyance of the continuous paper P at the printing speed, while the life extension mode process starts to drive the image carrier 34d in a post-start process where the conveyance of the continuous paper P is started at the printing speed.

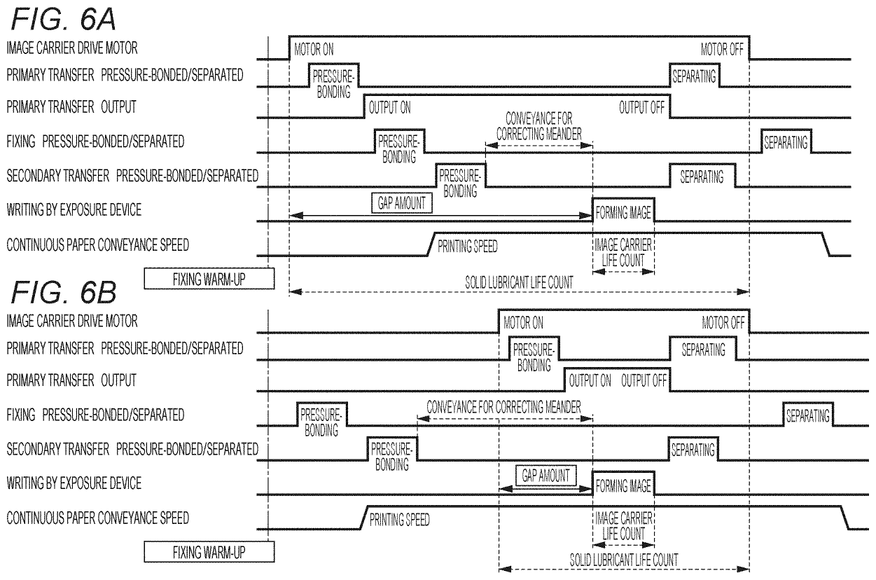

FIG. 6A and FIG. 6B are timing charts of the image forming operation of the image forming apparatus 3 according to the embodiment of the present disclosure. FIG. 6A illustrates a case of the normal mode process. FIG. 6B illustrates a case of the life extension mode process. Note that, in both cases of FIG. 6A and FIG. 6B, the operation is performed after warm-up of the fixing unit 35 is completed. In the normal mode process, as illustrated in FIG. 6A, the image carrier 34d is started to be driven by the image carrier drive motor 34f, the primary transfer roller 34e35 is shifted to a pressure-bonded state to be pressed to the intermediate transfer belt 34e1 by the primary transfer pressure adjusting unit 34e3, and the image former 34 is shifted to a state in which primary transfer can be performed via the primary transfer nip. Next, the second rotating member 353 is shifted to a pressure-bonded state in which the second rotating member 353 is pressure-bonded to the fixing belt 352c, and the intermediate transfer belt 34e1 is shifted to a state in which secondary transfer can be performed via the secondary transfer nip. While the above state is maintained, after the continuous paper P is conveyed for meander correction, writing to the image carrier 34d is started by the exposure device 34b. Next, after the image formation is completed, the intermediate transfer belt 34e1 is shifted to a state in which secondary transfer cannot be performed via the secondary transfer nip as shifting the intermediate transfer belt 34e1 in a separated state in which the primary transfer roller 34e35 is separated from the intermediate transfer belt 34e1 by the primary transfer pressure adjusting unit 34e3. Then, the driving of the image carrier 34d is stopped, the second rotating member 353 is shifted to a separated state in which the second rotating member 353 is separated from the fixing belt 352c, and the conveyance of the continuous paper P is stopped. As a result, the life count of the solid lubricant 342g is greatly increased, and the life of the lubricant consumption distance is greatly reduced. Therefore, the gap between the printing distance and the lubricant consumption distance increases.

On the other hand, in the case of the life extension mode process, as illustrated in FIG. 6B, the second rotating member 353 is shifted to a pressure-bonded state in which the second rotating member 353 is pressure-bonded to the fixing belt 352c, and the intermediate transfer belt 34e1 is shifted to a state in which secondary transfer can be performed via the secondary transfer nip. As this state is maintained, while the continuous paper P is being conveyed for meander correction, the image carrier 34d is started to be driven by the image carrier drive motor 34f, and the primary transfer pressure adjusting unit 34e3 causes the primary transfer roller 34e35 to transition to a pressure-bonded state in which the primary transfer roller 34e35 is crimped to the intermediate transfer belt 34e1, and the image former 34 is shifted to a state in which primary transfer can be performed via the primary transfer nip. Next, writing to the image carrier 34d is started by the exposure device 34b. Next, after the image formation is completed, the intermediate transfer belt 34e1 is shifted to a state in which secondary transfer cannot be performed via the secondary transfer nip as shifting the intermediate transfer belt 34e1 in a separated state in which the primary transfer roller 34e35 is separated from the intermediate transfer belt 34e1 by the primary transfer pressure adjusting unit 34e3. Then, the driving of the image carrier 34d is stopped, the second rotating member 353 is shifted to a separated state in which the second rotating member 353 is separated from the fixing belt 352c, and the conveyance of the continuous paper P is stopped. As a result, the life count of the solid lubricant 342g is greatly reduced, and thus the reduction in the life of the lubricant consumption distance is suppressed. Therefore, the gap between the printing distance and the lubricant consumption distance is reduced.

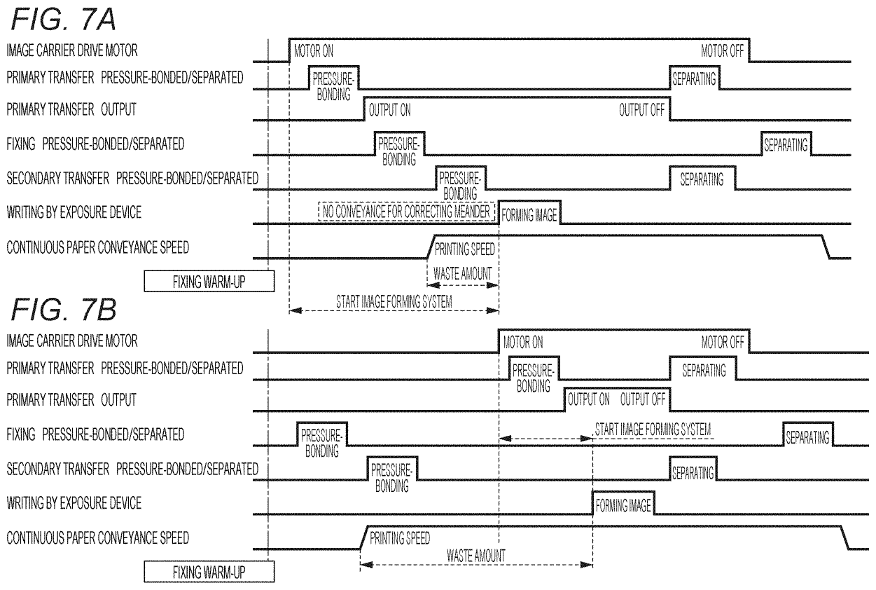

FIG. 7A and FIG. 7B are timing charts of other image forming operations of the image forming apparatus 3 according to the embodiment of the present disclosure. FIG. 7A illustrates the case of the normal mode process. FIG. 7B illustrates the case of the life extension mode process. In any one of FIG. 7A and FIG. 7B, the operation is performed after the warm-up of the fixing unit 35 is completed. In FIG. 7A, since the operation of conveying the continuous paper P for the meander correction is not executed, the amount of wasted continuous paper P is reduced compared to the case illustrated in FIG. 7B; however, a gap between the printing distance and the lubricant consumption distance is generated due to the startup operation of the image forming system as described above.

From the above description, in the present embodiment, the controller 301 starts the conveyance of the continuous paper P while the driving of the image carrier 34d is stopped. Therefore, even when the continuous paper P is conveyed at the printing speed, the image carrier 34d is not driven, and the lubricant consumption distance does not increase. Accordingly, since the gap between the printing distance and the lubricant consumption distance can be reduced, the replacement frequency of the drum unit can be reduced.

Further, in the present embodiment, the controller 301 starts driving the image carrier 34d when the continuous paper P is conveyed for a certain time or a certain distance. The meandering of the continuous paper P can be converged by starting the driving of the image carrier 34d after the continuous paper P is conveyed for a certain time or a certain distance at the printing speed. Further, since the drive of the image carrier 34d is not started until the meandering of the continuous paper P is converged, an increase in the lubricant consumption distance can be suppressed. Therefore, the gap between the printing distance and the lubricant consumption distance can be suppressed.

Further, in the present embodiment, when the controller 301 determines that the deviation of the continuous paper P is equal to or lower than the threshold value based on the detection result of the end detector 73, the controller 301 starts driving the image carrier 34d. In a case where the deviation of the continuous paper P is equal to or lower than the threshold value, since the meandering of the continuous paper P has converged, by starting to drive the image carrier 34d, the continuous paper P can be prevented from being kept conveyed more than needed. Therefore, waste of the continuous paper P and reduction of the productivity can be suppressed.

In the present embodiment, the controller 301 starts driving the image carrier 34d, and then forms the primary transfer nip between the image carrier 34d and the primary transfer roller 34e35. This prevents the intermediate transfer belt 34e1 and the image carrier 34d from rubbing each other due to the formation of the primary transfer nip before the driving of the image carrier 34d. Therefore, the quality of the image formed on the continuous paper P can be maintained.

In the above, the image forming apparatus 3, the paper feeding device 2, and the winding device 4 according to the present disclosure have been described according to the embodiment; however, the present disclosure is not limited thereto, and a change can be made within the scope of the present disclosure.

According to the present embodiment, an example in which the tension applying mechanism 61 is provided on the rear side of the paper feeding device 2 and the tension applying mechanism 62 is provided on the front side of the winding device 4 has been described; however, the present discloser is not particularly limited thereto. For example, the tension applying mechanisms 61 and 62 may be provided in the image forming apparatus 3.

In the present embodiment, the tension applying mechanism 61 has been described as an example including the weight 613 and the support member 614 separately; however, however, the present discloser is not particularly limited thereto. For example, the tension applying mechanism 61 may include a dancer arm in which a weight 613 and a support member 614 are integrally formed. In a case where the tension applying mechanism 61 includes a dancer arm, the air damper 615 may hold the dancer arm. The same applies to the tension applying mechanism 62.

In the present embodiment, the tension applying mechanism 61 has been described as an example in which the tension is applied to the continuous paper P by the weight 613; however, the present discloser is not particularly limited thereto. For example, the tension applying mechanism 61 may apply a tension to the continuous paper P by applying pressure to the dancer roller 612 by applying a load to the dancer roller 612 with an air cylinder or a spring. Note that, in a case where the tension applying mechanism 61 is an air cylinder, the pressure variation of the air is the tension variation when the pressure is applied by the air cylinder. Further, in a case of a spring, the tension applying mechanism 61 is provided with a damper for stabilizing the spring. The same applies to the tension applying mechanism 62.

Further, in the present embodiment, an example of the configuration in which the first rotating member 352 includes the fixing belt 352c as a belt heating method has been described; however, the present discloser is not particularly limited thereto. For example, the first rotating member 352 may be configured as a roller heating method. Further, an example in which, as a roller pressure method, the second rotating member 353 functions as a lower pressure roller has been described; however, the present discloser is not particularly limited thereto. For example, the second rotating member 353 may include a pressure belt as a belt pressure method.

Further, in the present embodiment, as the fixing unit 35, an example in which the toner image is fixed on the continuous paper P by the fixing nip has been described; however, the present discloser is not particularly limited thereto. For example, the fixing unit 35 may be flash fixing that fixes the toner image on the continuous paper P by the heat of light.

Further, in the present embodiment, an example in which the end detector 73 is configured by a reflective photoelectric sensor has been described; however, the present discloser is not particularly limited thereto. For example, the end detector 73 may be composed of a transmissive photoelectric sensor.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus that is capable of forming an image on a continuous paper, the image forming apparatus comprising:
an image former including an image carrier on which a toner image is formed as being driven; and
a hardware processor that controls conveyance of the continuous paper and driving of the image carrier,
wherein the hardware processor starts the conveyance of the continuous paper while stopping the drive of the image carrier.

2. The image forming apparatus according to claim 1, wherein the hardware processor starts to drive the image carrier in a case where the continuous paper is conveyed for a certain period of time or by a certain distance.

3. The image forming apparatus according to claim 1, further comprising
an end detector that detects deviation of the continuous paper,
wherein the hardware processor starts to drive the image carrier in a case where it is determined that the deviation is equal to or lower than a threshold value based on detection result of the end detector.

4. The image forming apparatus according to claim 1, further comprising
an end detector that detects deviation of the continuous paper,
wherein the hardware processor starts to drive the image carrier in a case where the deviation exceeds a threshold value in a detection result of the end detector and the continuous paper is conveyed for a certain period of time or by a certain distance.

5. The image forming apparatus according to claim 1, further comprising:
an intermediate transfer belt to which the toner image formed on the image carrier is primarily transferred; and
a primary transfer roller provided facing to the intermediate transfer belt,
wherein the hardware processor forms a primary transfer nip between the image carrier and the primary transfer roller after starting to drive the image carrier.
